(19) United States
(12) Patent Application Publication
(10) Pub. No.: US 2008/0064484 A1
(43) Pub. Date: Mar. 13, 2008

(54) Slot machine and playing method thereof

(75) Inventor: Hiroki Saito, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 11/892,204

(22) Filed: Aug. 21, 2007

(30) Foreign Application Priority Data
Aug. 28, 2006 (JP) 2006-230880

(51) Int. Cl. A63F 13/00

(52) U.S. Cl. 463/20

(57) ABSTRACT

When a plurality of symbols are rearranged in a plurality of display sections on a liquid crystal display unit, a dynamic character is moved from a second display portion through a first display portion toward a third display portion, and a payout for the player is provided according to a combination of symbols in a trail of a dynamic character in which the dynamic character has moved only when the dynamic character arrives at the third display portion.

### CROSS REFERENCE TO RELATED APPLICATION

This application claims benefit of priority under 35 U.S.C. §119 to Japanese Patent Application No. 2006-230880, filed on Aug. 28, 2006, the entire contents of which are incorporated by reference herein.

### BACKGROUND OF THE INVENTION

1. Field of the Invention

The present invention relates to a slot machine which allows a player to play a game, and particularly to a technique to configure a payline in an innovative style, which provides a payout.

2. Description of the Related Art

A conventional slot machine has a plurality of display sections configured in a matrix state on which a plurality of symbols are automatically rearranged and provides a payout based on the kind of symbols rearranged on a payline. The payline is generally provided as a linear line which crosses the plurality of display sections in a transverse direction or a diagonal direction. In recent times, U.S. Pat. No. 6,093,102 or U.S. Pat. No. 6,960,133 suggests a slot machine with various types of paylines which are nonlinear and even without the concept of paylines.

In the above-described slot machine, however, the payout is provided only when a predetermined number of symbols are displayed on the plurality of display sections configured in a matrix state. It has therefore the same display style as the conventional slot machine.

### SUMMARY OF THE INVENTION

With the foregoing problem in mind, the present invention is intended to provide a slot machine that provides a new entertainment factor by setting a trail of a dynamic character as a payline, which provides a payout.

It is a first aspect of the present invention to provide a slot machine comprising: a display including a first display portion, a second display portion and a third display portion, wherein the first display portion includes a plurality of display sections provided in a matrix state, on each of the plurality of display sections a symbol is displayed; the second display portion is provided next to one side of the first display portion; and the third display portion is provided next to another side of the first display portion; and a controller operable to arrange and rearrange automatically a plurality of symbols on the plurality of display sections, display and move a predetermined character from the second display portion toward the third display portion through the first display portion when a rearrangement is completed or a part of a rearrangement is completed, and determine a winning according to a combination of symbols in a trail in which the predetermined character has been moved and arrived at the third display portion from the second display portion through the first display portion.

In the slot machine according to the first aspect of the present invention, it is possible to provide a new slot machine which determines whether or not to provide a winning based on a combination of symbols in each trail of respective predetermined characters which are moved from the second display portion to the third display portion through the first display portion, the first display portion comprising a plurality of display sections on which a plurality of symbols are rearranged. That is, the trails in which the predetermined characters have been moved serve as the conventional paylines. Comparing with the conventional uniformed determination of the paylines, the present invention provides the paylines in an innovative style. Moreover, it is possible to add an excitement for the player to follow the formation process of paylines to be determined by the movements of the predetermined characters.

It is a second aspect of the present invention to provide a slot machine wherein the plurality of symbols include a first symbol which indicates a direction to move the predetermined character, and the controller moves the predetermined character on a symbol in a display section indicated by the first symbol in a current position of the predetermined character.

In the slot machine according to the second aspect of the present invention, since the plurality of symbols include the first symbol which indicates a direction to move a predetermined character, it is possible to add an excitement for the player to predict the movement of a predetermined character by following the first symbols before the predetermined character is moved.

It is a third aspect of the present invention to provide a slot machine wherein the plurality of symbols includes a second symbol, and the controller determines the winning according to the kind and number of the second symbols in the combination.

In the slot machine according to the third aspect of the present invention, since the plurality of symbols include the second symbol which relates to winnings, it is possible to add an excitement for the player to predict a winning by following the second symbols.

It is a fourth aspect of the present invention to provide a slot machine wherein the plurality of symbols includes a third symbol which prevents the predetermined character from being moved.

In the slot machine according to the fourth aspect of the present invention, since the plurality of symbols include the third symbol which prevents the predetermined character from being moved, it is possible to predict the movement of the predetermined character and at the same time to realize a complicated movement in which the predetermined character is prevented from being further moved when moved on the third symbol. In particular, when there are a plurality of predetermined characters, it becomes difficult to predict the movements of the predetermined characters. This gives the player more excitement to predict which predetermined character will arrive at the third display portion by following the plurality of predetermined characters.

It is a fifth aspect of the present invention to provide a slot machine comprising: a display including a first display portion, a second display portion and a third display portion, wherein the first display portion includes a plurality of display sections provided in a matrix state, on each of the plurality of display sections a symbol is displayed; the second display portion is provided next to one side of the first display portion; and the third display portion is provided next to another side of the first display portion; and a controller operable to arrange and rearrange automatically on the plurality of display sections a plurality of symbols including a first symbol which indicates a direction to move the predetermined character and a second symbol, display and move a predetermined character from the second display portion toward the third display portion through the first display portion when a rearrangement is completed or a part of a rearrangement is completed, and determine a winning according to the kind and number of the second symbols in a trail in which the predetermined character has been moved and arrived at the third display portion from the second display portion through the first display portion, wherein the controller moves the predetermined character on a symbol in a display section indicated by the first symbol in a current position of the predetermined character.

In the slot machine according to the fifth aspect of the present invention, it is possible to provide a new slot machine which determines whether or not to provide a winning based on a combination of symbols in each trail of respective predetermined characters which are moved from the second display portion to the third display portion through the first display portion, the first display portion comprising a plurality of display sections on which a plurality of symbols are rearranged.

Further, since the plurality of symbols include the first symbol which indicates a direction to move a predetermined character, it is possible to add an excitement for the player to predict the movement of a predetermined character by following the first symbols before the predetermined character is moved.

Furthermore, since the plurality of symbols include the second symbol which relates to winnings, it is possible to add an excitement for the player to predict a winning by following the second symbols.

It is a sixth aspect of the present invention to provide a playing method executed in a slot machine comprising: arranging and rearranging a plurality of symbols on a first display portion comprised of a plurality of display sections; displaying and moving a predetermined character from a second display portion toward a third display portion through the first display portion when a rearrangement is completed or a part of a rearrangement is completed; and determining a winning according to a combination of symbols in a trail in which the predetermined character has been moved and arrived at the third display portion from the second display portion through the first display portion.

In the playing method of a slot machine according to the sixth aspect of the present invention, it is possible to provide a new method executed in the slot machine which determines whether or not to provide a winning based on a combination of symbols in each trail of respective predetermined characters which are moved from the second display portion to the third display portion through the first display portion, the first display portion comprising a plurality of display sections on which a plurality of symbols are rearranged. That is, the trails in which the predetermined characters have moved serve as the conventional paylines. Comparing with the conventional uniformed determination of the paylines, the present invention provides the paylines in an innovative style. Moreover, it is possible to provide a strong expectation for the player whether or not the predetermined character arrives at the third display portion by following the formation process of paylines.

It is a seventh aspect of the present invention to provide a playing method executed in a slot machine further comprising: moving the predetermined character by overlapping the predetermined character on a symbol in a display section indicated by a first symbol in a current position of the predetermined character.

In the playing method of a slot machine according to the seventh aspect of the present invention, since the plurality of symbols include the first symbol which indicates a direction for a predetermined character to move, it is possible to add an excitement for the player to predict the movement of a predetermined character by following the first symbols before the predetermined character is moved.

It is an eighth aspect of the present invention to provide a playing method executed in a slot machine further comprising: determining the winning according to the kind and number of a second symbol in the combination.

In the playing method of a slot machine according to the eighth aspect of the present invention, since the plurality of symbols include the second symbol which relates to winnings, it is possible to add an excitement for the player to predict a winning by following the second symbols.

It is a ninth aspect of the present invention to provide a playing method executed in a slot machine further comprising: preventing the predetermined character from being moved to a next display section when the predetermined character is overlapped on a third symbol in a display section.

In the playing method of a slot machine according to the ninth aspect of the present invention, since the plurality of symbols include the third symbol which prevents the predetermined character from moving, it is possible to predict the movement of the predetermined character and at the same time to realize a complicated movement in which the predetermined character is prevented from being moved when moved on the third symbol. In particular, when there are a plurality of predetermined characters, it becomes difficult to predict the movements of the predetermined characters. This makes a pleasure more exciting to predict which predetermined character will arrive at the third display portion by following the plurality of predetermined characters.

It is a tenth aspect of the present invention to provide a playing method executed in a slot machine further comprising: controlling the movement of the predetermined character separately from the plurality of symbols.

In the playing method of a slot machine according to the tenth aspect of the present invention, since the movement of the predetermined characters and the displaying of the symbols are separately controlled, it is possible to realize an independent and complicated movement of the predetermined characters.

It is an eleventh aspect of the present invention to provide a playing method executed in a slot machine comprising: arranging and rearranging a plurality of symbols on a first display portion comprised of a plurality of display sections; displaying and moving a predetermined character from a second display portion toward a third display portion through the first display portion by overlapping the predetermined character on a symbol in a display section indicated by a first symbol in a current position of the predetermined character when a rearrangement is completed or a part of a rearrangement is completed; and determining a winning according to the kind and number of a second symbol in a trail in which the predetermined character has been moved and arrived at the third display portion from the second display portion through the first display portion.

In the playing method of a slot machine according to the eleventh aspect of the present invention, it is possible to provide a new method executed in the slot machine which determines whether or not to provide a winning based on a combination of symbols in each trail of respective predetermined characters which are moved from the second display portion to the third display portion through the first display portion, the first display portion comprising a plurality of display sections on which a plurality of symbols are rearranged. That is, the trails in which the predetermined characters have moved serve as the conventional paylines. Comparing with the conventional uniformed determination of the paylines, the present invention provides the paylines in an innovative style. Moreover, it is possible to provide a strong expectation for the player whether or not the predetermined character arrives at the third display portion by following the formation process of paylines.

Further, since the plurality of symbols include the first symbol which indicates a direction for a predetermined character to move, it is possible to add an excitement for the player to predict the movement of a predetermined character by following the first symbols before the predetermined character is moved.

Furthermore, since the plurality of symbols include the second symbol which relates to winnings, it is possible to add an excitement for the player to predict a winning by following the second symbols.

### BRIEF DESCRIPTION OF THE DRAWINGS

FIG. 1 is a flowchart showing a playing method of a slot machine according to an embodiment of the present invention.

FIG. 2 is a perspective view showing the slot machine according to the embodiment of the present invention.

FIG. 3 is an explanatory view showing symbols to be displayed on each display section on the slot machine and code numbers assigned to the respective symbols according to the embodiment of the present invention.

FIG. 4 is an explanatory view showing wining combinations to provide payouts and numbers of coins to be paid out assigned to the respective combinations according to the embodiment of the present invention.

FIG. 5 is a block diagram of a control circuit of the slot machine according to the embodiment of the present invention.

FIG. 6 is a flowchart showing a procedure of an authentication reading of a game program and a game system program by a mother board and a gaming board of the slot machine according to the embodiment of the present invention.

FIG. 7 is a flowchart showing a procedure of a base game executed by the slot machine according to another embodiment of the present invention.

FIG. 8 is a flowchart showing a procedure of a determination of symbols to be stopped, executed by the slot machine, according to the embodiment of the present invention.

FIG. 9 is a flowchart showing a procedure of a scroll control executed by the slot machine according to the embodiment of the present invention.

FIG. 10 is a view showing a location of each display portion on a liquid crystal display device and an example of symbols stopped on respective display sections.

FIG. 11 is a view showing dynamic characters on a departure display portion (second display portion) and symbols being scroll-displayed on a display portion (first display portion).

FIG. 12 is a view showing that the dynamic characters move on stopped symbols in display sections in a column “28a” indicated by symbols on the second display portion when symbols in a column “28b” are stopped.

FIG. 13 is a view showing that the dynamic characters move on symbols in next display sections indicated by symbols in previous display sections when symbols in a column “28c” are stopped.

FIG. 14 is a view showing that a dynamic character arrives at an arrival display portion (third display portion) when symbols in a column “28e” are stopped.

FIG. 15 is a view showing a trail in which the dynamic character has moved.

FIG. 16 is a view showing the first to third display portions and the plurality of display sections in the first display portion according to the embodiment of the present invention.

### DETAILED DESCRIPTION OF THE INVENTION

There will be explained a playing method and operations of a slot machine according to an embodiment of the present invention.

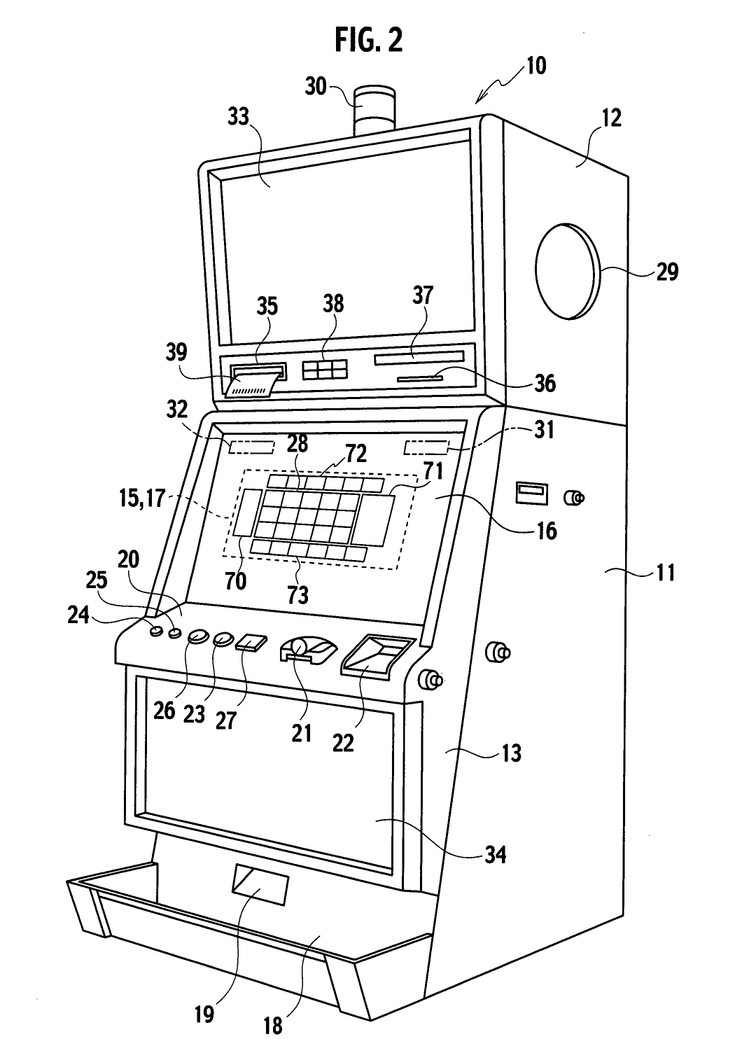

At first, there will be explained a display part of a slot machine 10, and symbols and predetermined characters to be displayed thereon with reference to FIGS. 2, 10, 11, and 16.

The slot machine 10 comprises a cabinet 11, a top box 12 provided on the cabinet 11, and a main door 13 provided on the front surface of the cabinet 11. The top box 12 has an upper image display panel 33 and the main door 13 has a lower image display panel 16 made of a transparent material. The lower image display panel 16 includes a display window 15. Inside the display window 15 is provided a liquid crystal display device 17 comprising a display portion 28 (first display portion), a departure display portion 70 (start, second display portion), an arrival display portion 71 (goal, third display portion), an upper symbol returning display portion 72 (first display portion), and a lower symbol returning display portion 73 (first display portion). Accordingly, images displayed on the liquid crystal display device 17 are visible to players through the display window 15.

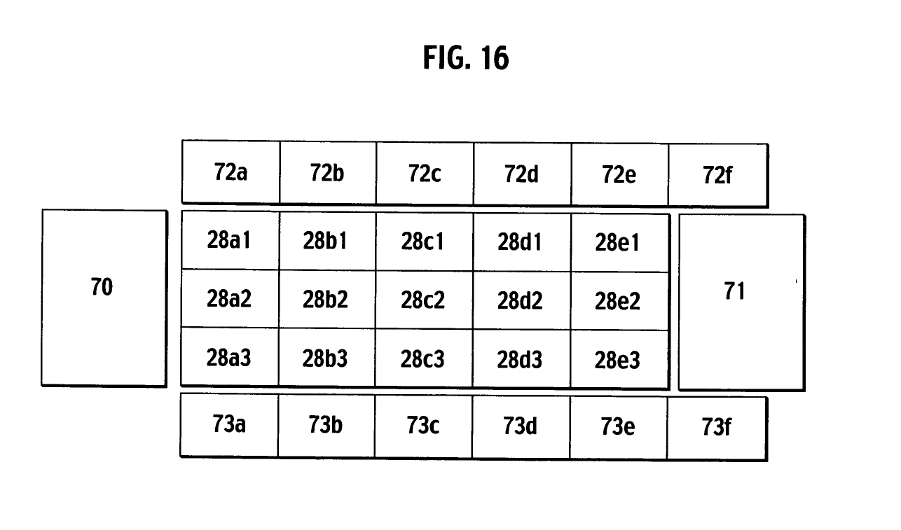

As shown in FIG. 16, the display portion 28 comprises a 3*5 matrix, a plurality of display sections “28a1 to 28e3”, in which symbols are displayed (to be arranged and rearranged). Note that suffixes “a to e” and “1 to 3” attached to the reference number “28” of the display section 28 respectively show columns and lines.

The departure display portion 70 is provided next to the left side of the display portion 28 and displays the predetermined characters (dynamic characters “X”, for example, frog characters) in a state before starting a movement toward the goal (refer to FIG. 11).

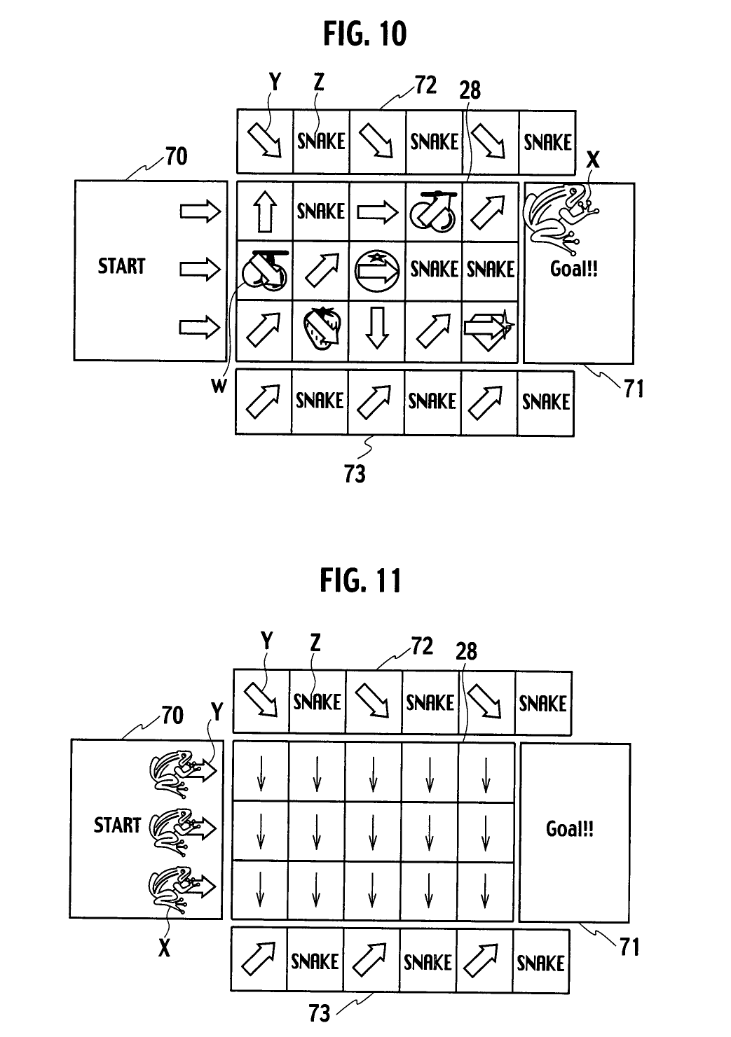

The arrival display portion 71 is provided next to the right side of the display portion 28 and displays one or more dynamic characters “X” which arrive from the second display portion through the first display portion (refer to FIG. 10).

As shown in FIG. 16, the upper symbol returning display portion 72 is provided adjacent to the upper side of the display portion 28 and has six display sections “72a to 72f”, each of which has the same size as that of the display portion 28 and in which symbols are displayed. The upper symbol returning display portion 72 is a portion for returning a dynamic character “X”, which moves from the display portion 28, to the display portion 28.

Similarly, the lower symbol returning display portion 73 is provided adjacent to the lower side of the display portion 28 and has six display sections “73a to 73f”, each of which has the same size as that of the display portion 28 and in which symbols are displayed. The lower symbol returning display portion 73 is a portion for returning a dynamic character “X”, which moves from the display portion 28, to the display portion 28.

Symbols displayed on the first display portion include a moving direction indicating symbol “Y” (first symbol) which indicates a direction for a dynamic character “X” to move, an winning related symbol “W” (second symbol), and a trap symbol “Z” (third symbol) which prevents a dynamic character “X” from moving.

In the upper and lower symbol returning display portions 72 and 73, the moving direction indicating symbols “Y” and the trap symbols “Z” are fixedly displayed.

Note that it is possible to rearrange the moving direction indicating symbols “Y” and trap symbols “Z” in the upper and lower symbol returning display portions 72 and 73 every unit game.

Next, there will be explained a playing method and operations of the slot machine.

The slot machine 10 executes an authentication process when powered on and activated (Step S100). In this authentication process, the slot machine 10 executes an initial verification process as a previous stage before starting a base game (unit game), for example, determining whether or not a program for operating a system works normally and is not tampered.

Next, the slot machine 10 executes the base game (Step S200). In the base game, the slot machine 10 starts scroll-displaying symbols on the display sections “28a1 to 28e3” when a player inserts one or more coins into a coin receiving slot 21, bets a desired number of credits on the current unit game, and pushes a spin button 23. Then, the slot machine 10 automatically stops scroll-displaying symbols on each column from left to right in sequence at a predetermined time interval (Step S300). That is, at first the symbols in the column “28a” are stopped, subsequently in the column “28b”, in the column “28c”, in the column “28d”, and in the column “28e” at a predetermined time interval. Note that one coin corresponds to one credit in this embodiment.

When all the symbols in the columns “28a to 28e” are automatically stopped, the slot machine 10 displays a plurality of dynamic characters “X” as if they move from the departure display portion 70 to the column “28a” and then from the column “28a” toward the arrival display portion 71 in sequence based on the moving direction indicating symbols “Y” (Step S400).

In particular, in this embodiment, when all the symbols in the columns “28a to 28e” are stopped, three frog characters “X” are erased from the second display portion 70 and then displayed on the symbols on respective display sections in the column “28a” indicated by the moving direction indicating symbols “Y” in the departure display portion 70. That is, when a symbol in the current display section includes a moving direction indicating symbol “Y”, the frog character “X” in the current display section is erased from the current display section and displayed in a next display section indicated by the moving direction indicating symbol “Y” in the current display section, being overlapped on the symbol in the next display section.

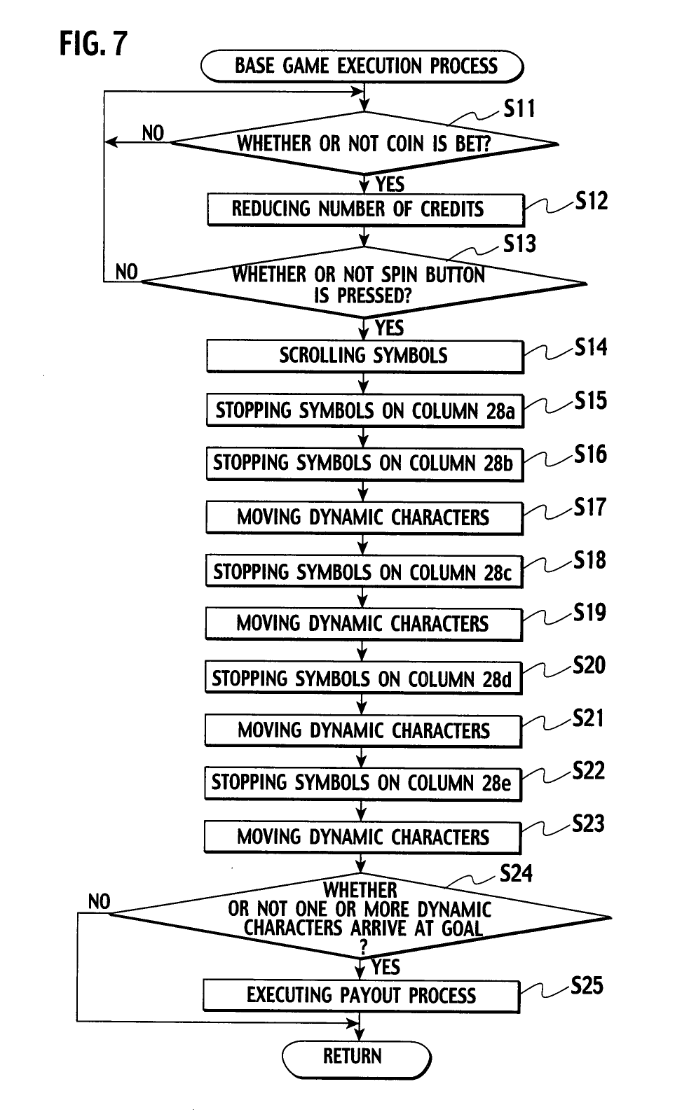

When the symbols include a letter character of “snake” as the trap symbol “Z”, a frog which is displayed on the trap symbol “Z” is displayed as if the snake swallowed the frog. A movement of the dynamic characters “X” according to another embodiment will be explained in detail later with reference to FIG. 7.

Next, the slot machine 10 determines whether or not one or more dynamic characters “X” arrive at the arrival display portion 71 (goal) (Step S500).

When one or more dynamic characters “X” arrive at the arrival display portion (goal) 71, the slot machine 10 determines a winning combination, which is the type and number of the winning related symbols, included in each trail of the respective dynamic characters (Step S600).

Next, the slot machine 10 pays out coins based on the number of dynamic characters “X” which arrive at the arrival display portion (goal) 71 and each determined winning combination in each trail of the dynamic characters “X” (Step S700).

The winning combination is a combination of predetermined symbols (winning related symbols) which provides the payout of a predetermined number of coins. When a winning combination is shown in the trail of a dynamic character “X”, a predetermined number of coins are paid out.

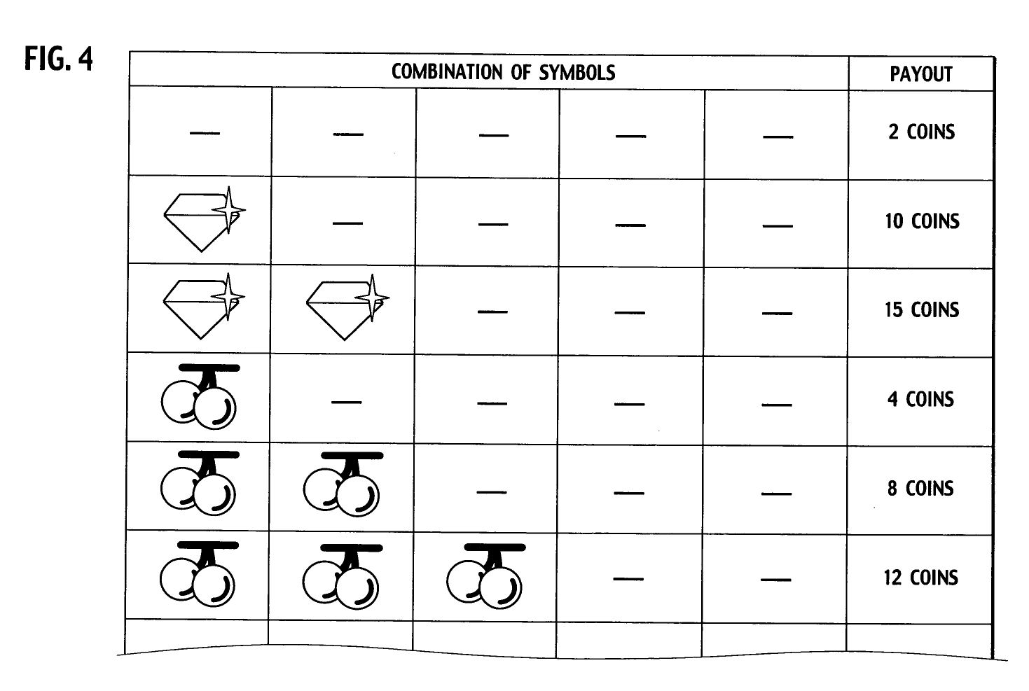

For example, when a trail in which a dynamic character “X” has moved includes one diamond of a winning related symbol, 10 coins per 1 BET are paid out according to a payout table in FIG. 4. The number of coins increases as the number of BET increases. For example, when the number of coins to be paid for 1 BET is five, 10 coins are paid out for 2 BETs. The payout may be done by physically paying out coins or electronically adding a count value to a memory provided in the slot machine 10.

One or more trails in which one or more dynamic characters “X” arrive at the arrival display portion 71 therefore serve as one or more paylines.

It is to be understood that the present invention is not limited to the liquid crystal display device 17 having the display sections “28a1 to 28e3” in the 3*5 matrix explained in the present embodiment.

In this embodiment, there is employed the dynamic character “X” that passes through the first display portion having dynamic movements with dynamic images in itself. However, the predetermined character is not limited to the above character. It is further possible to dynamically display a process of moving, for example, to show a process of a jumping of the frog character “X” from one display section to another display section. It is also possible to employ a static character with no movement in itself.

Note that a character other than the frog character may be employed as the dynamic character “X” to draw the attention of the player.

In the present embodiment, the player can get a fun in predicting a trail of a dynamic character by following the moving direction indicating symbols “Y” and trap symbols “Z” before a dynamic character “X” completes its moving. When the symbols in the upper and lower symbol returning display portions 72 and 73 are fixed, the player can get more fun because the prediction becomes easier. On the other hand, when the symbols in the upper and lower symbol returning display portions 72 and 73 are rearranged, the player can get more fun because the prediction is not easy and the difficulty in the prediction changes depending on the location and number of the symbols. It is therefore possible to have the variety of the game.

Note that though the present embodiment employs the trap symbols “Z” in the first display portion (display portion 28, and upper and lower symbol returning display portions 72, 73), it is also possible to employ them only in the display portion 28, or only in the upper and lower symbol returning display portions 72 and 73.

There will be explained a configuration of the slot machine 10 in detail according to the embodiment of the present invention with reference to FIG. 2. The slot machine 10 is installed in a game arcade.

The lower image display panel 16 has a transparent liquid crystal panel on which various information or effect images relating to a game are displayed during the game.

The lower image display panel 16 includes a number-of-credits display portion 31 and a number-of-payouts display portion 32. The number-of-credits display portion 31 is a portion where the number of credited coins is displayed as an image. The number-of-payouts display portion 32 is a portion where the number of coins to be paid out is displayed as an image when a winning combination is formed.

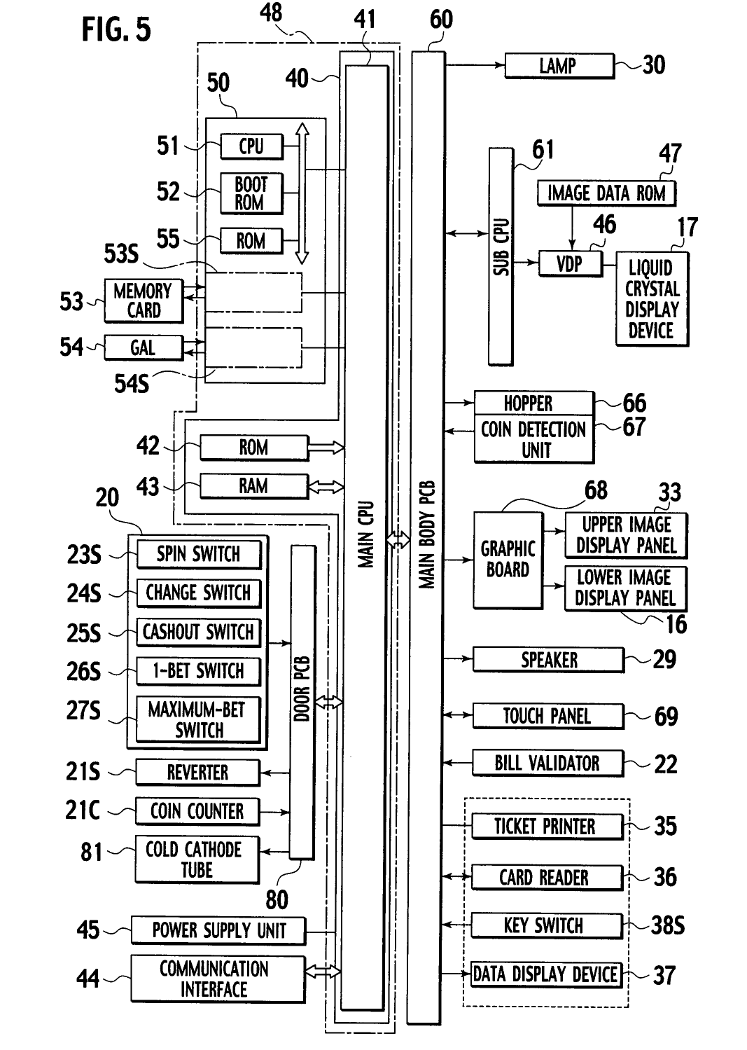

On the front side of the lower image display panel 16 is further provided a touch panel 69 (refer to FIG. 5), through which the player can input various instructions to the slot machine 10.

On the lower side of the lower image display panel 16 are provided a control panel 20, the coin receiving slot 21, and a bill validator 22. The coin receiving slot 21 is a slot where one or more coins are received into the cabinet 11. The control panel 20 comprises a plurality of buttons (a spin button 23, a change button 24, a cashout button 25, a 1-BET button 26, and a maximum-BET button 27) through which the player inputs instructions related to the process of a game to the slot machine 10. The spin button 23 is a button for inputting an instruction to start scrolling the symbols displayed on the display portion 28. The change button 24 is a button for requesting an exchange of money to a clerk in the game arcade. The cashout button 25 is a button for inputting an instruction to pay out the credited coins to a coin tray 18.

The 1-BET button 26 is a button for inputting an instruction to bet one coin on the current unit game from the credited coins. The maximum-BET button 27 is a button for inputting an instruction to bet the maximum number of coins (for example, 50) allowed to bet on one game on the current unit game.

The bill validator 22 identifies whether or not a bill is real and takes only real one into the cabinet 11. The bill validator 22 may be enabled to read a ticket attached with bar code 39 (described below). On the lower side of the control panel 20, that is the lower front side of the main door 13, is provided a belly glass 34 on which a character of the slot machine 10 and so on are drawn.

On a side surface of the top box 12 is provided a speaker 29 for outputting sounds. On the front side of the top box 12 is provided the upper image display panel 33 which has a liquid crystal panel on which, for example, effect images, or images introducing the contents of the game or explaining the rule of the game are displayed. Under the upper image display panel 33 are provided a ticket printer 35, a card reader 36, a data display device 37, and a keypad 38. The ticket printer 35 prints a barcode on a ticket, which comprises coded data regarding the number of credits, date, an identification number of the slot machine 10, and so on, and outputs as a ticket attached with bar code 39. With this ticket attached with bar code 39, the player can play a game on another slot machine or exchange to bills or the like at a cashier in the game arcade.

The card reader 36 reads out data from a smart card and writes data into the smart card. The smart card is possessed by a player, on which data identifying the player and regarding a history of games played by the player is stored.

The data display device 37 is composed of a fluorescent display, and displays, for example, data read by the card reader 36 or data input by the player through the keypad 38. The keypad 38 is used for inputting an instruction regarding the issue of a ticket or data.

As a game medium for executing a unit game, the slot machine 10 accepts coins, bills, or electronic valuable information equivalent to the coins or bills. Note that the game medium is not limited to the above and may be medals, tokens, electronic money, or tickets (tickets attached with bar codes, described below).

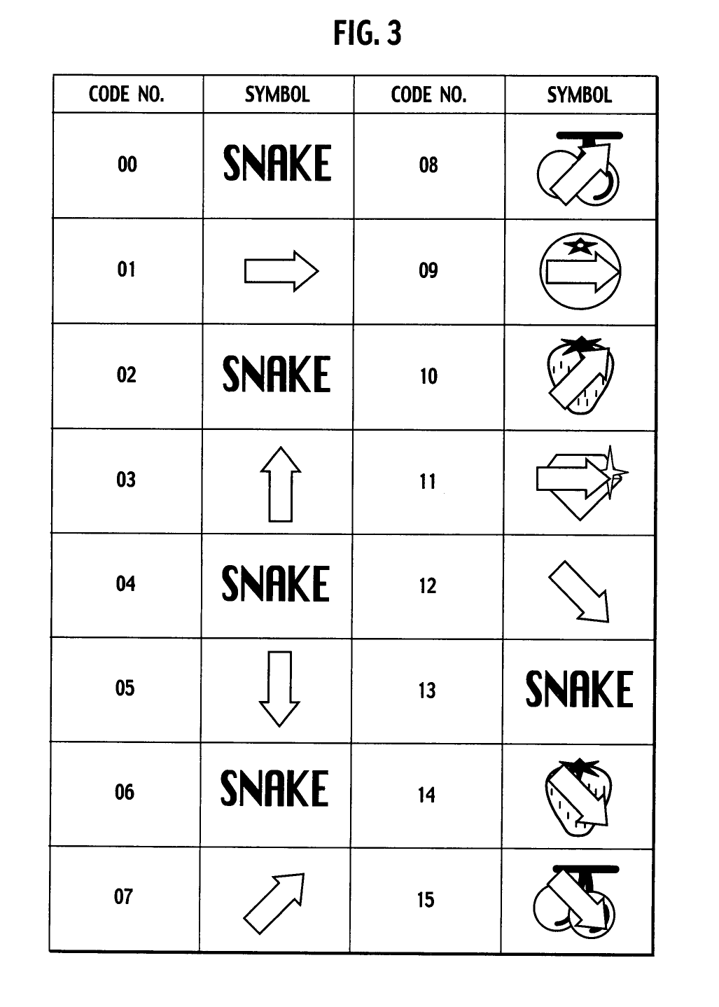

There will be explained the symbols displayed on the first display portion with reference to FIG. 3.

As shown in FIG. 3, sixteen kinds of symbols are prepared. The symbols have respective code numbers “00” to “15”. These symbols are randomly scrolled regardless of the code numbers.

The symbols include the letter character of “snake” (trap symbol “Z”), five kinds of arrows (moving direction indicating symbols “Y”), two kinds of cherries (winning related symbols “W”) with arrows (moving direction indicating symbols “Y”) overlapped thereon, one kind of orange (winning related symbol “W”) with an arrow (moving direction indicating symbol “Y”) overlapped thereon, two kinds of strawberries (winning related symbol “W”) with arrows (moving direction indicating symbols “Y”) overlapped thereon, and one kind of diamond (winning related symbol “W”) with an arrow (moving direction indicating symbol “Y”) overlapped thereon.

Note that the code number having an arrow (moving direction indicating symbol “Y”) serves as a flag to overlap a dynamic character on a symbol in a display section indicated by the arrow. For example, the code number “07” represents to overlap a dynamic character “X” on a symbol in an upper right display section (28, 72a to 72f) at a predetermined timing.

There will be explained the payout table with reference to FIG. 4.

The payout table is prepared to determine a payout when a dynamic character “X” arrives at the arrival display portion 71. The payout table defines the number of coins to be paid out for 1 BET for each combination of symbols.

For example, when a frog character “X” arrives at the arrival display portion 71 and has neither diamond nor cherry in its trail, which means the trail includes only the moving direction indication symbols “Y”, two coins for 1 BET are paid out. When a frog character “X” arrives at the arrival display portion 71 and has one diamond in its trail, ten coins for 1 BET are paid out. When a plurality of frog characters “X” arrive at the arrival display portion 71, the payouts of respective frog characters “X” are summed up.

There will be explained a control circuit of the slot machine 10 shown in FIG. 2 with reference to FIG. 5.

The control circuit comprises a controller 48, a main body Printed Circuit Board (main body PCB) 60, a sub Central Processing Unit (sub CPU)61, a door Printed Circuit Board (door PCB) 80, and various switches and sensors. The controller 48 comprises a mother board 40 and a gaming board 50.

The gaming board 50 comprises a Central Processing Unit (CPU) 51, a Read Only Memory (ROM) 55 and a boot Read Only Memory (boot ROM) 52, which are interconnected by an internal bus, a card slot 53S adapted for a memory card 53, and a IC socket 54S adapted for a Generic Array Logic (GAL) 54.

The memory card 53 stores a game program and a game system program. The game program includes a stop symbol determination program for determining code numbers corresponding to symbols to be stopped in the respective display sections “28a1 to 28e3” in the 3*5 matrix. The stop symbol determination program includes symbol weighted data corresponding to a plurality of payout rates (for example, 80%, 84%, 88%). The symbol weighted data shows a relationship between a code number of each symbol (refer to FIG. 3) and one or more random numbers which belong to a predetermined range of numeric numbers (0 to 256) with regard to the respective display sections “28a1 to 28e3” in the 3*5 matrix.

The payout rate is determined based on payout rate setting data output from the GAL 54. The symbols to be stopped are determined based on the symbol weighted data corresponding to the determined payout rate.

The card slot 53S is configured to be suitable for the insertion and removal of the slot card 53 and connected to the mother board 40 by an IDE bus. Accordingly, it is possible to change the kind or contents of a game to be played on the slot machine 10 by removing the memory card 53 from the card slot 53S, storing another game program or game system program in the removed memory card 53, and re-inserting the memory card 53 into the card slot 53S.

The game program also includes a program relating to the procedure of the game, a program regarding to the overlapped display of the dynamic characters “X”, and image data and sound data to be output during the game.

The GAL 54 comprises a plurality of input ports and an output port. When data is input to one of the plurality of input ports, data corresponding to the input data is output from the output port. The data output from the output port is the above-described payout rate setting data.

The IC socket 54S is configured to be suitable for insertion and removal of the GAL 54 and connected to the mother board 40 by a PCI bus. Accordingly, it is possible to change the payout rate setting data output from the GAL 54 by removing the GAL 54 from the IC socket 54S, rewriting the program stored in the removed GAL 54, and re-inserting the GAL 54 into the IC socket 54S.

The CPU 51, the ROM 55 and the boot ROM 52 which are interconnected by an internal bus, are connected to the mother board 40 by a PCI bus. The PCI bus transmits signals between the mother board 40 and the gaming board 50 and supplies electric power from the mother board 40 to the gaming board 50. The ROM 55 stores country identification information and an authentication program. The boot ROM 52 stores a preliminary authentication program and a program (boot code) for the CPU 51 to initiate the preliminary authentication program.

The authentication program is a program (tamper checking program) for authenticating the game program and the game system program, that is for verifying and proving that the game program and the game system program are not tampered. Accordingly, the authentication program is described in accordance with the procedure of the authentication of the game program and the game system program. The preliminary authentication program is a program for authenticating the above-described authentication program. The preliminary authentication program is described in accordance with the procedure of proving that the authentication program to be subjected to the authentication process is not tampered, that is, the procedure of authenticating the authentication program.

The mother board 40 comprises a main Central Processing Unit (CPU) 41, a Read Only Memory (ROM) 42, a Random Access Memory (RAM) 43, and a communication interface 44.

The main CPU 41 has a function to control the entirety of the slot machine 10. In particular, the main CPU 41 executes the following controls through the sub CPU 61: displaying the departure display portion 70, the arrival display portion 71, the upper symbol returning display portion 72, and the lower symbol returning display portion 73 on the liquid crystal display device 17; scroll-displaying the symbols displayed on the display sections “28a1 to 28e3” on the liquid crystal display device 17 when credits are bet and the spin button 23 is pressed, and determining the symbols to be stopped; and stopping the determined symbols for every column of the display sections “28a1 to 28e3” in sequence at a predetermined interval; overlapping dynamic characters “X” on predetermined symbols. Note that the moving display of the dynamic characters “X” is controlled as if they move along a moving direction indicated by each moving direction indicating symbol “Y” (described in detail below).

The sub CPU 61 includes a dynamic character control unit 61a (not shown) for displaying and scrolling the dynamic characters “X” and a symbol control unit 61b (not shown) for displaying the symbols.

The main CPU 41 also determines a payout of credits with reference to the payout table shown in FIG. 4, when one or more dynamic characters “X” are displayed on the arrival display portion 71. The payout of credits is determined based on the kind and number of predetermined symbols in each trail of the respective dynamic characters “X” which arrive at the arrival display portion 71.

The ROM 42 stores a program such as a Basic Input/Output System (BIOS) to be executed by the main CPU 41 and data to be used permanently. When the BIOS is executed, the main CPU 41 executes an initialization process for each peripheral device and starts a reading process for the game program and the game system program, which are stored in the memory card 53, through the gaming board 50.

The RAM 43 stores data and programs which are used when the main CPU 41 executes processes.

The communication interface 44 communicates with a host computer installed in the game arcade through a communication line.

To the mother board 40 are connected the main body PCB (described below) 60, the door PCB 80 through respective universal serial buses (USBs), and a power supply unit 45. When the electric power is supplied from the power supply unit 45 to the mother board 40, the main CPU 41 of the mother board 40 is activated. The electric power is further supplied to the gaming board 50 through the PCI bus, and the CPU 51 is thus activated.

To the main body PCB 60 and the door PCB 80 are connected instruments and devices, which generate input signals to be input into the main CPU 41, and instruments and devices, which are controlled by control signals output from the main CPU 41. The main CPU 41 executes the game program and the game system program stored in the RAM 43 based on the input signals input thereto and stores a result of processing in the RAM 43 or transmits control signals to the respective instruments and devices.

To the main body PCB 60 are connected a lamp 30, the sub CPU 61, a hopper 66, a coin detection unit 67, a graphic board 68, the speaker 29, the touch panel 69, the bill validator 22, the ticket printer 35, the card reader 36, a key switch 38S, and the data display device 37.

The sub CPU 61 receives an instruction from the main CPU 41 and controls scrolling and stopping symbols displayed on the display sections “28a1 to 28e3” in the 3*5 matrix through the sub CPU 61b. The sub CPU 61 is connected to a Video Display Processor (VDP) 46.

The VDP 46 is controlled through the sub CPU 61 to read out the image data of the symbols stored in an image data Read Only Memory (image data ROM) 47 and form scroll image to be displayed on the liquid crystal display device 17, and to output the scroll image on the liquid crystal display device 17. Moreover, the VDP 46 is controlled through the sub CPU 60 (61a) to read out the image data of dynamic characters “X” stored in the image data ROM 47 and to notify the player the moving status of the dynamic characters “X” by overlapping the dynamic characters “X” on the respective symbols in the display sections indicated by the moving direction indicating symbols “Y”.

The hopper 66 is provided inside the cabinet 11 and pays out a predetermined number of coins from a coin payout opening 19 to the coin tray 18 based on a control signal from the main CPU 41. The coin detection unit 67 is provided inside the coin payout opening 19 and outputs an input signal to the main CPU 41 when the coin detection unit 67 detects the payout of the predetermined number of coins from the coin payout opening 19.

The graphic board 68 controls displaying image on the upper and lower image display panels 33 and 16 other than the image displayed on the liquid crystal display device 17 based on a control signal output from the main CPU 41. The graphic board 68 also comprises a VDP which generates image data based on a control signal output from the main CPU 41 and a video RAM which temporally stores the image data generated by the VDP.

The bill validator 22 reads the image of bills and only accepts real ones. Accepting a real bill, the bill validator 22 outputs an input signal to the main CPU 41 based on the amount of the bill. The main CPU 41 stores the number of credits corresponding to the amount of the bill notified by the input signal in the RAM 43.

The ticket printer 35 prints a barcode on a ticket based on a control signal output from the main CPU 41 and outputs as the ticket attached with bar code 39.

The card reader 36 reads out the data of the smart card and sends the data to the main CPU 41, and writes data into the smart card based on a control signal from the main CPU 41. The key switch 38S is provided on the key pad 38 and outputs an input signal to the main CPU 41 when the player operates the key pad 38.

The data display device 37 displays data read by the card reader 36 or data input by the player with the key pad 38 based on a control signal output from the main CPU 41.

To the door PCB 80 are connected the control panel 20, a reverter 21S, a coin counter 21C, and a cold cathode tube 81. The control panel 20 includes a spin switch 23S corresponding to the spin button 23, a change switch 24S corresponding to the change button 24, a cashout switch 25S corresponding to the cashout button 25, a 1-BET switch 26S corresponding to the 1-BET button 26, and a maximum-BET switch 27S corresponding to the maximum BET button 27. Each switch outputs an input signal to the main CPU 41 when the player presses a button corresponding to each switch.

The coin counter 21C is provided inside the coin receiving slot 21 and identifies whether or not a coin inserted by the player is real. The coin counter 21C discharges coins other than the real ones. Detecting a real one, the coin counter 21C outputs an input signal to the main CPU 41.

The reverter 21S which is operated based on a control signal output from the main CPU 41 sorts coins identified as real by the coin counter 21C into a cash box (not shown) provided in the slot machine 10 or the hopper 66. When the hopper 66 is already filled with coins, newly identified coins are sorted by the reverter 21S into the cash box. When the hopper 66 is not filled with coins, newly identified coins are sorted into the hopper 66.

The cold cathode tube 81 is provided at the back of the upper and lower image display panels 33 and 16 and functions as a backlight. The cold cathode tube 81 is turned on based on a control signal output from the main CPU 41.

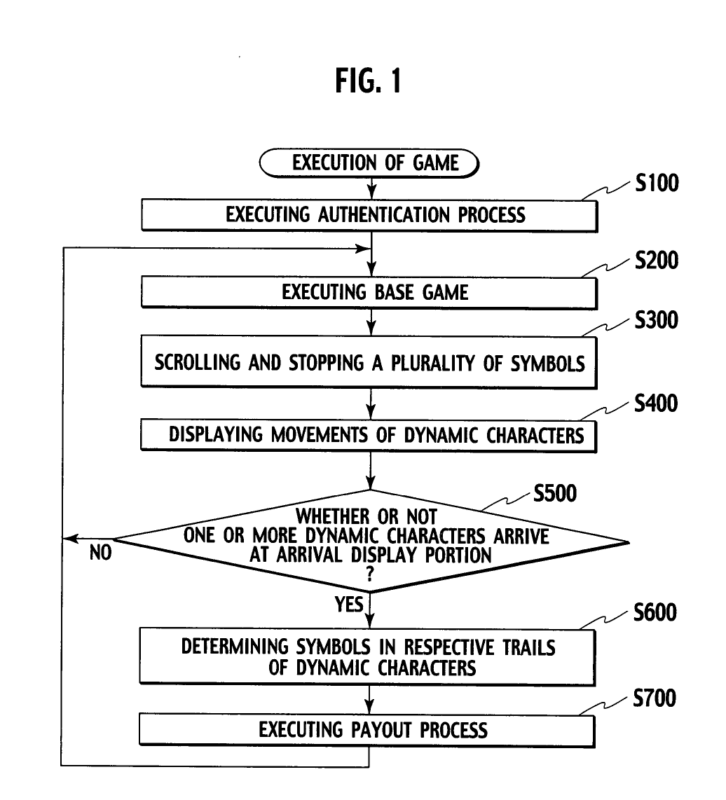

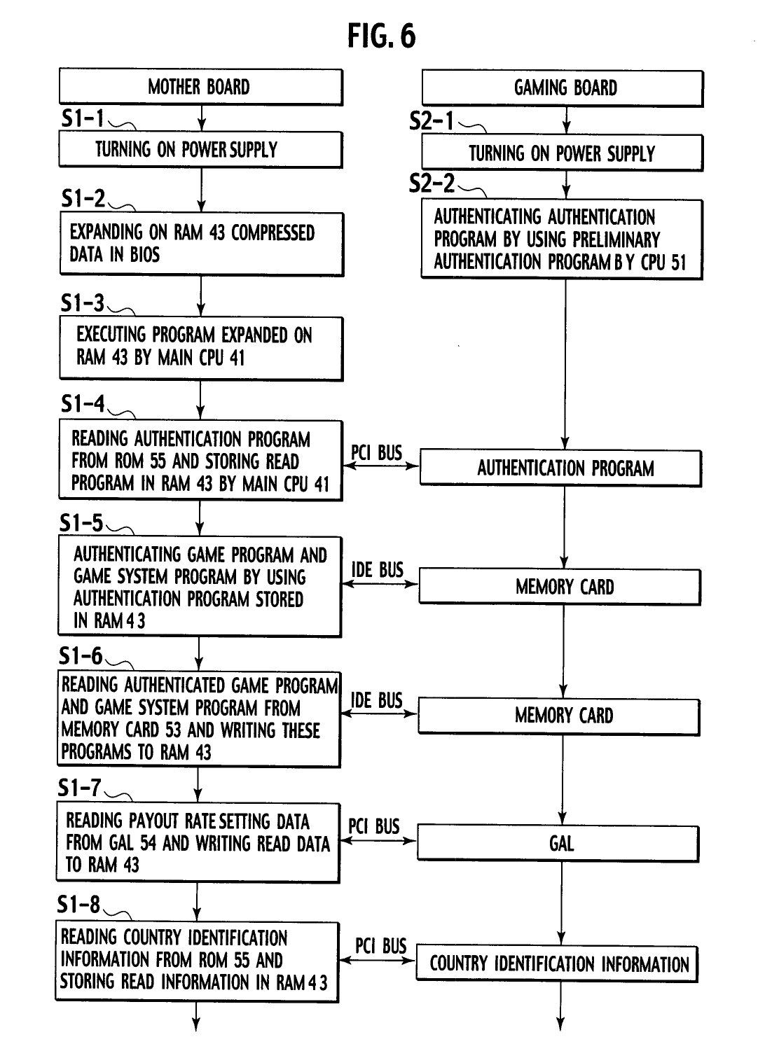

There will be explained the authentication reading process (Step S100 in FIG. 1) on the mother board 40 and the gaming board 50 with reference to FIG. 6. Note that it is assumed on the gaming board 50 that the memory card 53 is inserted into the card slot 53S and the GAL 54 is inserted into the IC socket 54S.

When the power supply unit 45 is switched on, the mother board 40 and the gaming board 50 are activated (Steps S1-1, S2-1). After the mother board 40 and the gaming board 50 are activated, there are executed mutually different processes simultaneously. On the gaming board 50, the CPU 51 reads out the preliminary authentication program stored in the boot ROM 52. Then, before the authentication program stored in the ROM 55 of the gaming board 50 is captured to the mother board 40, the CPU 51 verifies and proves in advance that the authentication program is not tampered in accordance with the read-out preliminary authentication program (Step S2-2).

On the mother board 40, the main CPU 41 executes the BIOS stored in the ROM 42 and expands, on the RAM 43, compressed data included in the BIOS (Step S1-2). Then, the main CPU 41 executes the BIOS expanded on the RAM 43 and performs a diagnostics and an initialization of the various peripheral devices (Step S1-3).

The main CPU 41 then reads out the authentication program stored in the ROM 55 of the gaming board 50 through the PCI bus and stores the read-out authentication program in the RAM 43 (Step S1-4).

The main CPU 41 accesses the memory card 53 attached to the card slot 53S through the IDE bus, and then reads out the game program and the game system program, which are stored in the memory card 53.

In accordance with the authentication program stored in the RAM 43, the main CPU 41 verifies and proves that the read-out game program and game system program are not tampered (Step S1-5).

When the authentication process is normally ended, the main CPU 41 stores the authenticated game program and game system program in the RAM 43 (Step S1-6). Next, the main CPU 41 accesses the GAL 54 attached to the IC socket 54S through the PCI bus, reads in payout rate setting data from the GAL 54, and stores the read-in payout rate setting data in the RAM 43 (Step S1-7). Next, the main CPU 41 reads out the country identification information stored in the ROM 55 of the gaming board 50 through the PCI bus and stores the read-out country identification information in the RAM 43 (Step S1-8).

After executing the above-described processes, the main CPU 41 of the controller 48 progresses the below-described base game by sequentially reading out and executing the game program and the game system program.

There will be explained the base game process (Step S200 in FIG. 1) according to another embodiment of the present invention with reference to FIG. 7. The difference is that in FIG. 7 the dynamic characters “X” start moving when the rearrangement of symbols in the predetermined columns “28a”, and “28b” is completed, while in FIG. 1 the dynamic characters “X” start moving when the rearrangement of symbols in all columns “28a to 28e” is completed.

The main CPU 41 determines whether or not a coin is bet (Step S11). Specifically, the main CPU 41 determines whether or not to have received either an input signal output from the 1-BET switch 26S when the 1-BET button 26 is pushed or an input signal output from the maximum-BET switch 27S when the maximum-BET button 27 is pushed. When no coin is bet, the main CPU 41 remains at Step S1.

When a coin is bet, the main CPU 41 reduces the number of credits, which is stored in the RAM 43, in response to the number of bet coins (Step S12). Note that, when the number of bet coins is larger than the number of credits stored in the RAM 43, the main CPU 41 remains at Step S11 without executing the process for reducing the number of credits stored in the RAM 43. Moreover, when the number of bet coins exceeds an upper limit value (50 in this embodiment) of the coins allowed to bet on one unit game, the main CPU 41 proceeds to Step S13 after reducing the number of credits stored in the RAM 43 only by the coins allowed to bet on one unit game (50).

Next, the main CPU 41 determines whether or not the spin button 23 is pressed (Step S13) by determining whether or not to have received an input signal output from the spin switch 23S.

When the spin button 23 is not pressed, the main CPU 41 returns to Step S11. Note that the main CPU 41 cancels the result of the reduction in Step S12 when the spin button 23 is not pressed, for example, when an instruction to end the game is input without the press of the spin button 23.

It is noted that the step of reducing the number of credits (Step S12) may be executed after the main CPU 41 determines that the spin button 23 is pressed (YES in Step S13) after a coin is bet (Step S11).

When the spin button 23 is pressed in Step S13, the main CPU 41 executes through the sub CPU 61 (61b) a process of scroll-displaying symbols displayed on the respective display sections “28a1 to 28e3” (Step S14). In this step, there are also displayed the departure display section 70, the arrival display section 71, and the upper and lower symbol returning display portions 72 and 73.

As shown in FIG. 11, there are displayed three moving direction indicating symbols “Y” which indicate right in the departure display portion 70, corresponding to respective three lines of the display portion 28. Three frog characters “X” (first, second, and third from top to bottom) are overlapped on the three moving direction indicating symbols “Y”, respectively.

The upper symbol returning display 72 fixedly displays a moving direction indicating symbol “Y” (first symbol) and a letter character of “snake” as the trap symbol “Z” (third symbol) alternately in the display sections “72a to 72f”. The moving direction indicating symbols “Y” indicate lower right for returning a frog character “X” to the display portion 28.

Similarly, the lower symbol returning display 73 fixedly displays a moving direction indicating symbol “Y” and a letter character of “snake” as the trap symbol “Z” alternately in the display sections “73a to 73f”. The moving direction indicating symbols “Y” indicate upper right for returning a frog character “X” to the display portion 28.

Next, the main CPU 41 executes a process of stopping symbols in the column “28a” (Step S15). In this symbol stopping process, the main CPU 41 executes the stop symbol determination program stored in the RAM 43 to determine and stop symbols in the three display sections “28a1 to 28a3”. As shown in FIG. 10, there are stopped a moving direction indicating symbol “Y” (first symbol) which indicates up in the display section “28a”, a cherry (second symbol) with a moving direction indicating symbol “Y”, which indicates lower right, overlapped thereon in the display section “28a2”, and a moving direction indicating symbol “Y” which indicates upper right (first symbol) in the display section “28a3”.

Next, the main CPU 41 executes a process of stopping the symbols in the column “28b” (Step S16). In this symbol stopping process, the main CPU 41 executes the stop symbol determination program stored in the RAM 43 to determine and stop symbols in the three display sections “28b1 to 28b3”. As shown in FIG. 10, there are stopped a letter character of “snake” (third symbol) in the display section “28b1”, a moving direction indicating symbol “Y” which indicates upper right in the display section “28b2”, and a strawberry with a moving direction indicating symbol “Y”, which indicates lower right, overlapped thereon in the display section “28b3”.

Next, the main CPU 41 executes a process of displaying the three frog characters “X” as if they move from the departure display portion 70 to the symbols in the column “28a”, when the symbols in the column “28b” are stopped (Step S17).

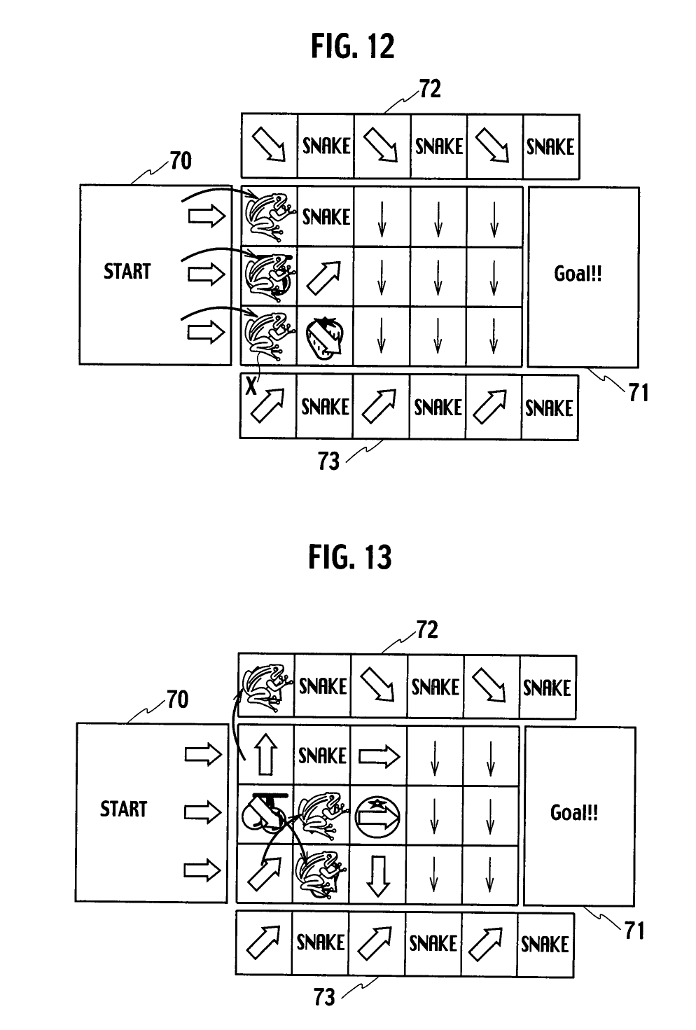

As shown in FIG. 12, when the symbols in the column “28b” are stopped, the three frog characters “X” are erased from the departure display portion 70 and overlapped on the symbols in the display sections “28a1 to 28a3” according to the moving direction indicating symbols “Y” in the departure display portion 70. This makes the three frog characters “X” as if they move from the departure display portion 70 to the respective display sections “28a1”, “28a2”, and “28a3” indicated by the moving direction indicating symbols “Y” when the symbols in the column “28b” are stopped.

The main CPU 41 determines the respective display sections to which the frog characters “X” should move based on respective flags of the moving direction indicating symbols “Y” on which the dynamic characters “X” are currently overlapped. For example, as the first frog character “X” in the departure display portion 70 is displayed on the moving direction indicating symbol “Y” which indicates right, the main CPU 41 overlaps the first frog character “X” on the display section “28a” immediate right to the current position.

Note that the display process for the erase and the overlap of a frog character “X” may be realized by switching two kinds of images, that is a symbol with a frog character “X” and the symbol without the frog character “X”. In this case, there will be prepared a symbol with a frog character “X” for each symbol in FIG. 3 with its code number, for example, a code number “01A” for a right arrow and a code number “01B” for the right arrow with a frog character “X”.

Next, the main CPU 41 executes a process of stopping symbols in the column “28c” (Step S18). In this symbol stopping process, the main CPU 41 executes the stop symbol determination program stored in the RAM 43 to determine and stop symbols in the three display sections “28c1 to 28c3”. As shown in FIG. 13, there are stopped a moving direction indicating symbol “Y” which indicates right in the display section “28c1”, an orange with a moving direction indicating symbol “Y” which indicates right overlapped thereon in the display section “28c2”, and a moving direction indicating symbol “Y” which indicates down in the display section “28c3”.

Next, the main CPU 41 executes a process of displaying the three frog characters “X” as if they move from the column “28a” to next display sections (Step S19). As shown in FIG. 13, when the symbols in the column “28c” are stopped, the three frog characters “X” are erased from the column “28a” and overlapped on the symbols in the display sections “72a”, “28b2”, and “28b3” indicated by the respective moving direction indicating symbols “Y” in the display sections “28a1 to 28a3”.

This looks as if the three frog characters “X” move along the directions of the arrows, from the display sections “28a1 to 28a3” to “72a”, “28b2”, and “28b3”, when the symbols in the column “28c” are stopped.

Next, the main CPU 41 executes a process of stopping symbols in the column “28d” (Step S20). In this symbol stopping process, the main CPU 41 executes the stop symbol determination program stored in the RAM 43 to determine and stop symbols in the three display sections “28d1 to 28d3” of the column “28d”. There are stopped a cherry with a moving direction indicating symbol “Y”, which indicates upper right, overlapped thereon in the display section “28d1”, a letter character of “snake” in the display section “28d2”, and a moving direction indicating symbol “Y” which indicates upper right in the display section “28d3” (refer to FIG. 10).

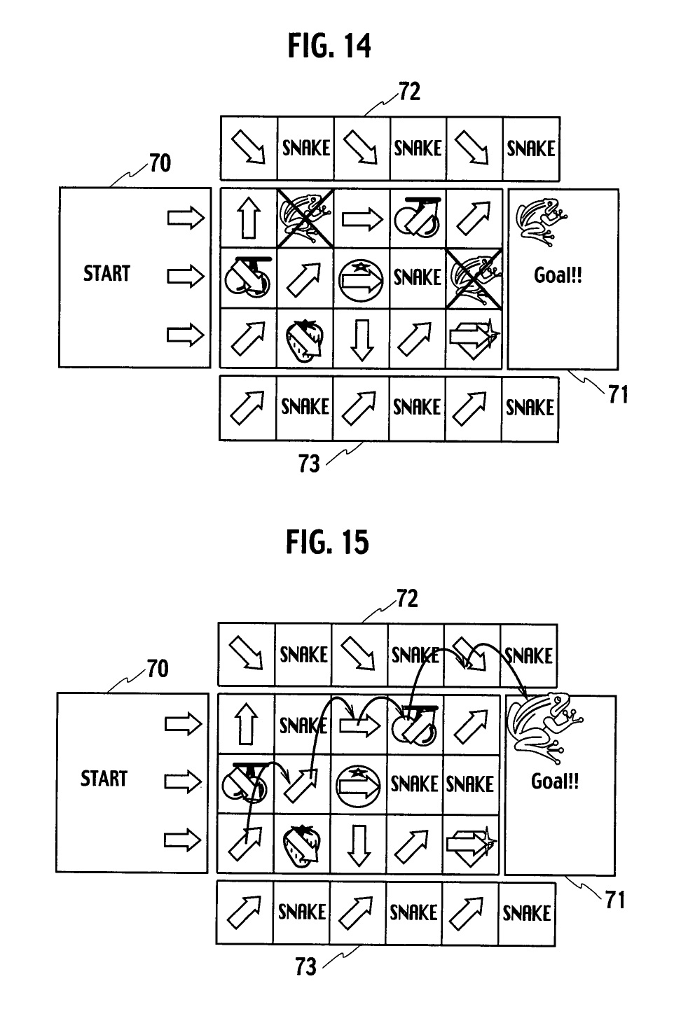

Next, the main CPU 41 executes a process of displaying the three dynamic characters “X” as if they move from the current display sections to the next display sections (Step S21). When the symbols in the column “28d” are stopped, the three frog characters “X” are erased from the display sections “72a”, “28b2”, and “28b3” and overlapped on the symbols in the display sections “28b1”, “73c”, and “28c1” indicated by the respective moving direction indicating symbols “Y” in the previous display sections “72a”, “28b2”, and “28b3”. Since the display section “28b1” has the snake symbol “Z”, there is overlapped an “X -mark” on the frog character “X” (refer to FIG. 14).

This looks as if the first frog character “X” moves from the display section “72a” to “28b1” and is eaten by the snake, the second frog character “X” moves from the display section “28b3” to “73c”, and the third frog character “X” moves from the display section “28b2” to “28c” (the process is not shown).

Next, the main CPU 41 executes a process of stopping symbols in the column “28e” (Step S22). In this symbol stopping process, the main CPU 41 executes the stop symbol determination program stored in the RAM 43 to determine and stop symbols in the three display sections “28e1 to 28e3” of the column “28e”. There are stopped a moving direction indicating symbol “Y” , which indicates upper right, overlapped thereon in the display section “28e1”, a letter character of “snake” in the display section “28e2”, and a diamond with a moving direction indicating symbol “Y” , which indicates right, overlapped thereon in the display section “28e3” (refer to FIG. 10).

Next, the main CPU 41 executes a process of displaying the two frog characters “X” as if they move from the current display sections to the next display sections (Step S23). When the symbols in the column “28e” are stopped, the two frog characters “X” are erased from the display sections “73c”, and “28c1” and overlapped on the symbols in the display sections “28d3”, and “28d1” indicated by the respective moving direction indicating symbols “Y” in the previous display sections “72c”, and “28c1”. Subsequently, the two frog characters “X” are erased from the display sections “28d3” and “28d1”, and overlapped on the symbols in the display sections “28e2” and “72e”. Since the display section “28e2” has the snake symbol “Z”, there is overlapped an “X-mark” on the second frog character “X” . Then, as shown in FIG. 10, the third frog is erased from the display section “72e” and displayed on the arrival display portion 71 (goal).

This looks as if the second frog character “X” moves from the display section “28d3” to “28e2” and is eaten by the snake, and the third frog character “X” moves from “28d1” to “72e” to the arrival display portion 71.

Then, the main CPU 41 determines whether or not one or more frog characters “X” have arrived at the arrival display portion 71 (Step S24).

Next, when one or more frog characters “X” have arrived at the arrival display portion 71 (YES in Step S24), the main CPU 41 pay out coins according to the number of the frog characters “X” which arrive at the goal and respective winning combinations (Step S25).

As shown in FIG. 15, as the third frog character “X” has one cherry symbol “W” in its trail, 4 coins for 1 BET are paid out (refer to FIG. 4). That is, a trail in which a frog character “X” has moved serves as a payline. Note that when the frog character “X” has no winning related symbols in its trail, two coins for 1 BET are paid out (refer to FIG. 4).

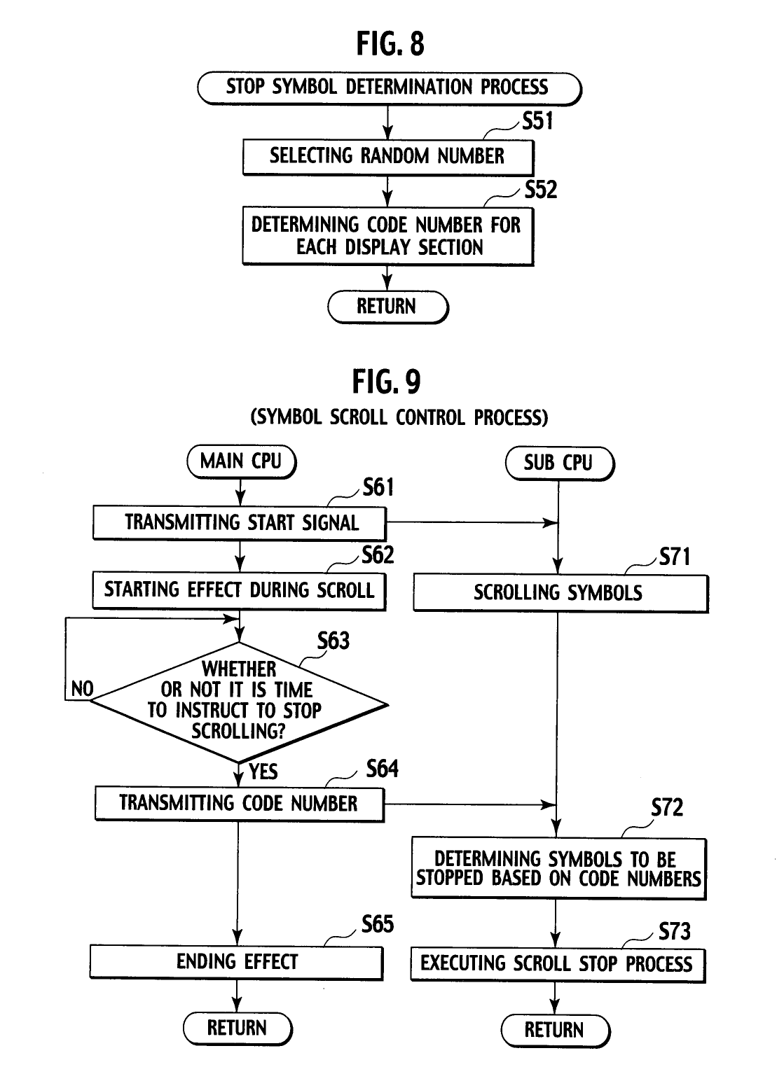

There will be explained a process of stop symbol determination (Step S15 in FIG. 7) in the base game process with reference to FIG. 8.

The main CPU 41 performs this process by executing the stop symbol determination program stored in the RAM 43.

The main CPU 41 executes a random number generating program included in the stop symbol determination program to select respective random numbers corresponding to the display sections “28a1 to 28e3” from a numeric range of 0 to 255 (Step S51).

Next, the main CPU 41 determines respective code numbers (refer to FIG. 3) for the display sections “28a1 to 28e3” based on the selected random numbers, referring to the symbol weighted data corresponding to the payout rate setting data output from the GAL54 and stored in the RAM 43 (Step S52).

There will be explained the process of scroll control (Step S14 in FIG. 7) in the base game process with reference to FIG. 9. This process is executed between the main CPU 41 and the sub CPU 61.

The main CPU 41 transmits a start signal to the sub CPU 61 (61b) to start scroll-displaying symbols in the display sections of the display portion 28 provided on the liquid crystal display device 17 (Step S61). Receiving the start signal from the main CPU 41, the sub CPU 61 (61b) outputs an instruction of the scroll-displaying of symbols to the VDP 46. The VDP 46 reads out image data stored in the image data ROM 47, and performs scrolling on the display sections.

Then, the main CPU 41 executes effects in the scrolling of symbols (Step S62). There are performed an image displaying on the lower image display panel 16 and a sound output from the speaker 29 for a predetermined term (for example, 3 seconds) depending on the result of stop symbol determination process (Step S15 in FIG. 7).

Next, the main CPU 41 determines whether or not to instruct to stop the scrolling (Step S63 in FIG. 9).

When the main CPU 41 determines not to stop the scrolling in Step S63, the process is returned to the Step S63 and continues executing the effect in the scrolling. When the main CPU 41 determines to stop the scrolling in Step S63, the main CPU 41 transmits to the sub CPU 61 (61b) the code numbers of the symbols stored in the RAM 43 (Step S64). Receiving the code numbers of the symbols from the main CPU 41, the sub CPU 61 (61b) determines the symbols to be stopped corresponding to the code numbers (Step S72).

Then, the stop process of the scrolling is executed, and symbols are displayed on the respective display sections (Step S73). Then, the display process of the effect image is stopped (Step S65).

The slot machine 10 according to the present embodiments provides the game having the extremely innovative style. In particular, after the plurality of symbols are rearranged on the plurality of display sections provided in the matrix state, or before the completion of the rearrangement, the dynamic characters are displayed as if they move from the second display portion 70 toward the third display portion 71 through the first display portion 28, 72, and 73 according to the moving direction indicating symbols “Y”, and when the dynamic characters arrive at the third display portion 71, the payout for the player is determined according to the combinations of the winning related symbols in each trail of the respective dynamic characters “X” in which they have moved. It is therefore possible to provide the player with a strong expectation whether or not the dynamic characters “X” arrive at the goal while the player follows the moving of the dynamic characters. Moreover, comparing to the conventional slot machine, it is possible to provide the player with a large expectation whether or not the payout is executed since the respective trails of the dynamic characters serve as paylines.

Furthermore, it is possible to provide the player with a further expectation which ways the dynamic characters “X” will move, since the symbols include the moving direction indicating symbol “Y” which indicates a direction for the dynamic character “X” to move and the trap symbol “Z”, which prevents the moving of the dynamic character “X”.

There has been explained the embodiments of the slot machine according to the present invention. However, the embodiments only illustrate specific examples, and do not limit the present invention in particular. It is possible to appropriately change designs of specific configurations of the respective means and the like. Moreover, the effects described in the embodiments of the present invention only list the most suitable effects generated from the present invention, and the effects from the present invention are not limited to those described in the embodiments of the present invention.

What is claimed is:

1. A slot machine comprising:
a display including a first display portion, a second display portion and a third display portion,
wherein
the first display portion includes a plurality of display sections provided in a matrix state, on each of the plurality of display sections a symbol is displayed;
the second display portion is provided next to one side of the first display portion; and
the third display portion is provided next to another side of the first display portion; and
a controller operable to arrange and rearrange automatically a plurality of symbols on the plurality of display sections, display and move a predetermined character from the second display portion toward the third display portion through the first display portion when a rearrangement is completed or a part of a rearrangement is completed, and determine a winning according to a combination of symbols in a trail in which the predetermined character has been moved and arrived at the third display portion from the second display portion through the first display portion.

2. The slot machine according to claim 1, wherein the plurality of symbols include a first symbol which indicates a direction to move the predetermined character, and
the controller moves the predetermined character on a symbol in a display section indicated by the first symbol in a current position of the predetermined character.

3. The slot machine according to claim 2, wherein the plurality of symbols includes a second symbol, and
the controller determines the winning according to the kind and number of the second symbols in the combination.

4. The slot machine according to claim 3, wherein the plurality of symbols includes a third symbol which prevents the predetermined character from being moved.

5. A slot machine comprising:
a display including a first display portion, a second display portion and a third display portion,
wherein
the first display portion includes a plurality of display sections provided in a matrix state, on each of the plurality of display sections a symbol is displayed;
the second display portion is provided next to one side of the first display portion; and
the third display portion is provided next to another side of the first display portion; and
a controller operable to arrange and rearrange automatically on the plurality of display sections a plurality of symbols including a first symbol which indicates a direction to move the predetermined character and a second symbol, display and move a predetermined character from the second display portion toward the third display portion through the first display portion when a rearrangement is completed or a part of a rearrangement is completed, and determine a winning according to the kind and number of the second symbols in a trail in which the predetermined character has been moved and arrived at the third display portion from the second display portion through the first display portion,
wherein the controller moves the predetermined character on a symbol in a display section indicated by the first symbol in a current position of the predetermined character.

6. A playing method executed in a slot machine comprising:
arranging and rearranging a plurality of symbols on a first display portion comprised of a plurality of display sections;
displaying and moving a predetermined character from a second display portion toward a third display portion through the first display portion when a rearrangement is completed or a part of a rearrangement is completed; and
determining a winning according to a combination of symbols in a trail in which the predetermined character has been moved and arrived at the third display portion from the second display portion through the first display portion.

7. The playing method according to claim 6, further comprising: moving the predetermined character by overlapping the predetermined character on a symbol in a display section indicated by a first symbol in a current position of the predetermined character.

8. The playing method according to claim 7, further comprising: determining the winning according to the kind and number of a second symbol in the combination.

9. The playing method according to claim 8, further comprising: preventing the predetermined character from being moved to a next display section when the predetermined character is overlapped on a third symbol in a display section.

10. The playing method according to claim 6, further comprising: controlling the movement of the predetermined character separately from the plurality of symbols.

11. A playing method executed in a slot machine comprising:
arranging and rearranging a plurality of symbols on a first display portion comprised of a plurality of display sections;
displaying and moving a predetermined character from a second display portion toward a third display portion through the first display portion by overlapping the predetermined character on a symbol in a display section indicated by a first symbol in a current position of the predetermined character when a rearrangement is completed or a part of a rearrangement is completed; and
determining a winning according to the kind and number of a second symbol in a trail in which the predetermined character has been moved and arrived at the third display portion from the second display portion through the first display portion.
